(19) United States
(12) Patent Application Publication
(10) Pub. No.: US 2007/0096650 A1
(43) Pub. Date: May 3, 2007

(54) Plasma display panel

(76) Inventor: Seung-Hyun Son, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/524,616

(22) Filed: Sep. 20, 2006

(30) Foreign Application Priority Data
Oct. 31, 2005 (KR) 10-2005-0103460

(51) Int. Cl. H01J 17/49

(52) U.S. Cl. 313/582; 313/584

(57) ABSTRACT

Provided is a plasma display panel that can be easily manufactured. The plasma display panel includes: a first substrate and a second substrate separated from each other by a predetermined gap and opposing each other; barrier ribs disposed between the first substrate and the second substrate and partitioning a plurality of discharge cells; discharge electrode pairs causing a discharge in the discharge cells; and shell structures disposed inside the discharge cells and having a discharge gas filled in the shell.

### BACKGROUND OF THE INVENTION

This application claims the priority of Korean Patent Application No. 10-2005-0103460, filed on Oct. 31, 2005, in the Korean Intellectual Property Office, the disclosure of which is incorporated herein in its entirety by reference.

### FIELD OF THE INVENTION

The present embodiments relate to a plasma display panel (PDP), and more particularly, to a PDP having a new structure that can be easily manufactured

### DESCRIPTION OF THE RELATED ART

Plasma display panels (PDP) have recently replaced conventional cathode ray tube (CRT) display devices. In a PDP, a discharge gas is sealed between two substrates on which a plurality of discharge electrodes are formed, a discharge voltage is applied, phosphor formed in a predetermined pattern by ultraviolet rays generated by the discharge voltage is excited whereby a desired image is obtained.

In order to make the PDP highly precise and fine, a discharge space in which a discharge occurs should be very small. However, as the discharge space is reduced, a process of forming a phosphor layer in the discharge space cannot be easily performed. In addition, barrier ribs that partition the discharge space are generally formed using a sandblasting process. It is very difficult to manufacture highly precise and fine barrier ribs using the sandblasting process. Furthermore, the number of processes of manufacturing the PDP is very large, which increases manufacturing time and costs.

### SUMMARY OF THE INVENTION

The present embodiments provide a plasma display panel (PDP) having a new structure that can be easily manufactured.

According to an aspect of the present embodiments, there is provided a plasma display panel including: a substrate; and a shell structure disposed on the substrate and having a shell and a discharge gas filled in the shell.

According to another aspect of the present embodiments, there is provided a plasma display panel including: a first substrate and a second substrate separated from each other by a predetermined gap and opposing each other; barrier ribs disposed between the first substrate and the second substrate and partitioning a plurality of discharge cells; discharge electrode pairs causing a discharge in the discharge cells; and shell structures disposed inside the discharge cells and having a discharge gas filled in the shell.

### BRIEF DESCRIPTION OF THE DRAWINGS

The above and other aspects and advantages of the present embodiments will become more apparent by describing in detail exemplary embodiments thereof with reference to the attached drawings in which:

FIG. 1 is a partially cutaway and exploded perspective view of a plasma display panel (PDP) according to an embodiment;

FIG. 2 is a cross-sectional view taken along line II-II of FIG. 1;

FIGS. 3A and 3B show photos of a shell manufactured using MgF₂;

FIGS. 4A through 4G illustrate a method of manufacturing the PDP illustrated in FIG. 1;

FIG. 5 shows a photo of a resultant structure in which a second substrate and barrier ribs are integrated into a single unit using the method illustrated in FIGS. 4A through 4G;

FIG. 6 is a partially cross-sectional view of a modified example of the PDP illustrated in FIG. 1;

FIG. 7 is a partially cutaway and exploded perspective view of a PDP according to another embodiment; and

FIG. 8 is a cross-sectional view taken along line VIII-VIII of FIG. 7.

### DETAILED DESCRIPTION OF THE INVENTION

The present embodiments will now be described more fully with reference to the accompanying drawings, in which exemplary embodiments are shown. Like reference numerals denote like elements.

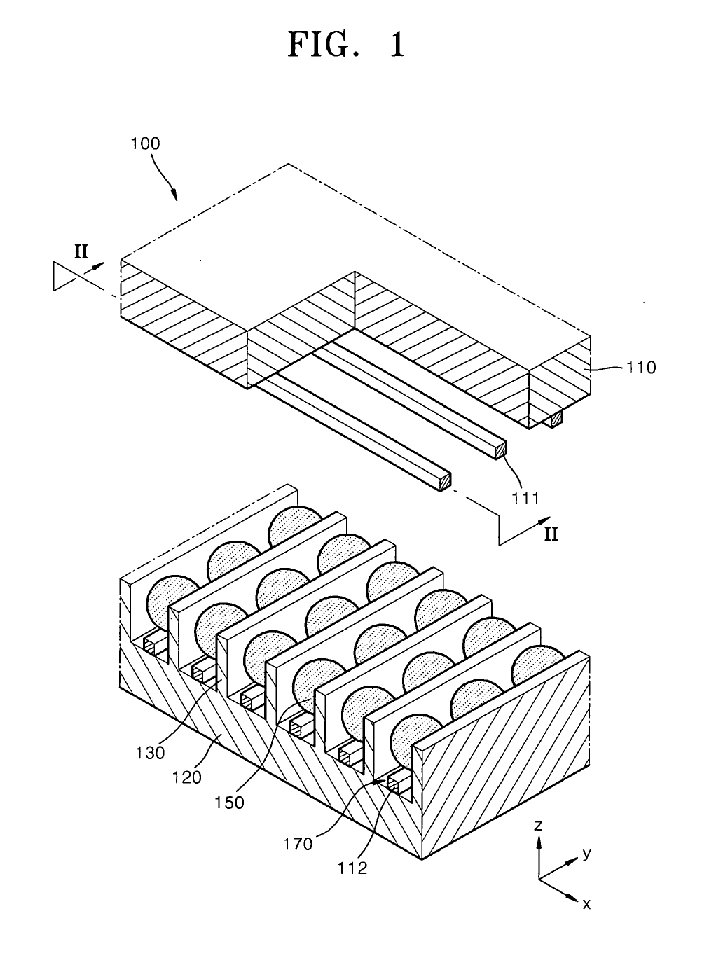

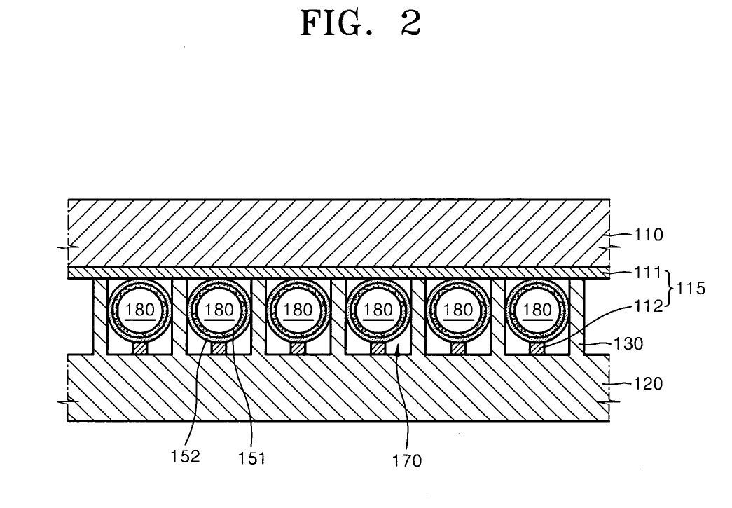

FIGS. 1 and 2 illustrate a plasma display panel (PDP) 100 according to an embodiment. FIG. 1 is a partially cutaway and exploded perspective view of the PDP 100, and FIG. 2 is a cross-sectional view taken along line II-II of FIG. 1.

The PDP 100 includes a first substrate 110 and a second substrate 120 that oppose each other and are combined with each other. The first substrate 110 and the second substrate 120 are separated from each other by a predetermined gap and define red, green, and blue discharge cells 170 corresponding to red, green, and blue subpixels. The first substrate 111 and the second substrate 120 may be formed of a flexible material. Various flexible materials may be used. The first substrate 110 and the second substrate 120 may include silicon rubber, polydimethylsiloxane (PDMS) or polyester. However, the present embodiments are not limited to this and the first substrate 110 and the second substrate 120 may also be formed of glass.

A plurality of discharge electrode pairs 115 in which a discharge occurs in discharge cells 170 are disposed between the first substrate 110 and the second substrate 120. Each discharge electrode pair 115 includes a first electrode 111 and a second electrode 112 which extend to cross each other. A detailed description thereof will now be described.

First electrodes 111 are disposed on an inner side surface of the first substrate 110. The first electrodes 111 are separated from one another by a predetermined gap and extend to be parallel to one another. One first electrode 111 corresponds to each discharge cell 170, extends along a first direction (x direction) and has a striped shape. In addition, the first electrodes 111 may be formed, for example, of indium tin oxide (ITO) for visible rays transmission ratio improvement. Since, in ITO, large voltage drop occurs in a lengthwise direction, an additional bus electrode may be disposed on the ITO.

Second electrodes 112 are disposed on an inner side surface of the second substrate 120. The second electrodes 112 are separated from one another by a predetermined gap and extend to be parallel to one another. One second electrode 112 corresponds to each discharge cell 170, extends along a second direction (y direction) that crosses the first direction (x direction) and has a striped shape. In addition, the second electrodes 112 may be formed, for example, of indium tin oxide (ITO) for visible rays transmission ratio improvement. Like in the first electrodes 111, an additional bus electrode may be disposed on the ITO.

The discharge cells 170 are partitioned by barrier ribs 130 interposed between the first substrate 110 and the second substrate 120. The barrier ribs 130 define a space in which shell structures 150 will be arranged. Referring to FIG. 1, the barrier ribs 130 have a striped shape that extends along the second direction (y direction). The discharge cells 170 are disposed in a matrix arrangement by the barrier ribs 130. The barrier ribs 130 may be separately formed independent of the first substrate 110 and the second substrate 120. However, for the convenience of manufacture, the barrier ribs 130 may be integrated with the first substrate 110 or the second substrate 120. In FIGS. 1 and 2, the barrier ribs 130 and the second substrate 120 are integrated into a single unit.

The shell structures 150 are disposed inside the discharge cells 170. One shell structure 150 may be disposed in each discharge cell 170 or a plurality of shell structures 150 may be disposed in each discharge cell 170. Each shell structure 150 includes a shell 151, a discharge gas (not shown), and a phosphor layer 152. The shell 151 defines a space 180 in which a discharge occurs and has a spherical shape. A discharge gas is sealed in the space defined by the shell 151. When voltage is applied to the first electrode 111 and the second electrode 112, a discharge occurs. The discharge gas may include an inert gas including Xe, Kr, Ne, Ar, and He or a mixture thereof or at least one of Hg, N₂, and D₂.

The shell 151 seals the discharge gas and may be formed of a material including MgF₂, MgO or Si₃N₄. Such materials have a high transmission ratio of UV rays generated by the discharge gas and stabilizing properties. In particular, the shell 151 may be formed of MgF₂. This is because a UV rays transmission ratio of MgF₂ having a wavelength less than about 250 nm is higher through MgF₂ than other materials. When the discharge gas includes at least one of Hg, N₂, and D₂, the shell 151 may be formed of a material including MgF₂, MgO or Si₃N₄ having a high transmission ratio in a long wavelength region since UV rays generated by the discharge gas have a long wavelength greater than about 250 nm.,

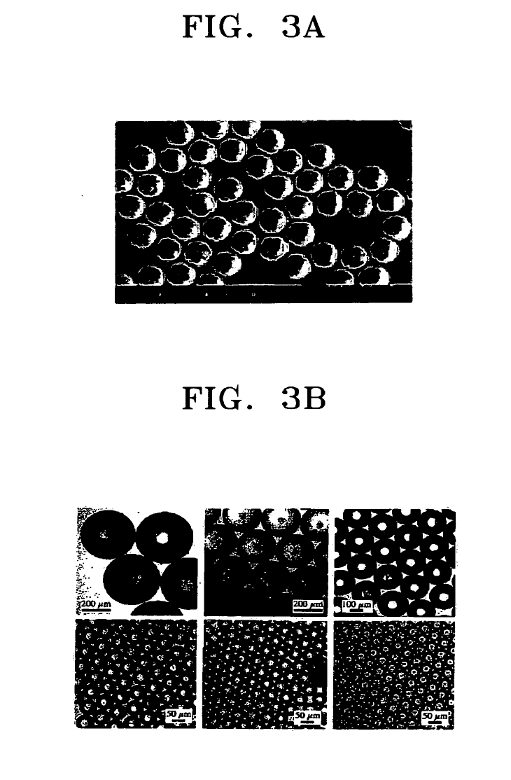

Characteristics of the shell 151 and a method of manufacturing the same are disclosed in U.S. Pat. Nos. 6,669,961, 6,073,578, 6,060,128, 5,948,483, and 5,344,676, and U.S. patent application Publication Nos. 20050123614, 20040022939, and 20020054912, each of which is hereby incorporated in its entirety by reference. Photos of a shell manufactured using MgF₂ are shown in FIGS. 3A and 3B. The shell 151 can be manufactured using micro sphere manufacturing technology disclosed in U.S. Pat. No. 6,669,961, which is hereby incorporated in its entirety by reference. The size of the shell 151 can have a diameter from about 1 micron to about 1000 microns.

Phosphor layers 152 producing red, green, and blue light are formed on an outer surface of the shell 151. The phosphor layers 152 include components that emit visible rays from ultraviolet (UV) rays. The phosphor layers 152 formed in red discharge cells include phosphor such as Y(V,P)O₄:Eu, the phosphor layers 152 formed in green discharge cells include phosphor such as Zn₂SiO₄:Mn, and the phosphor layers 152 formed in blue discharge cells include phosphor such as BAM:Eu.

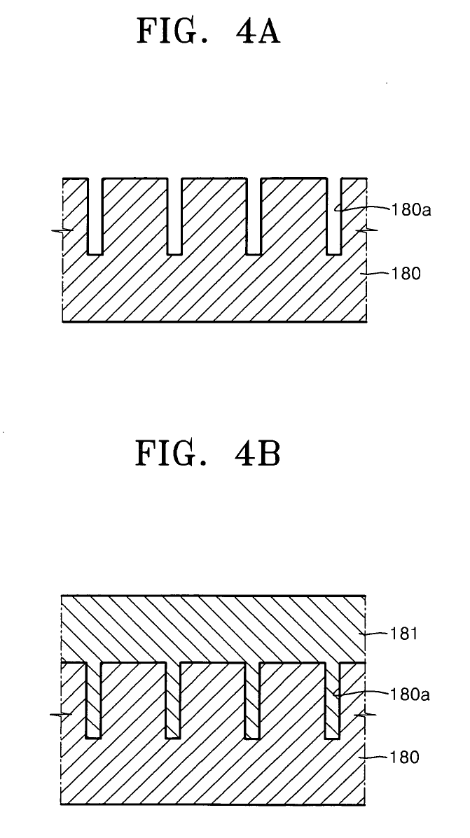

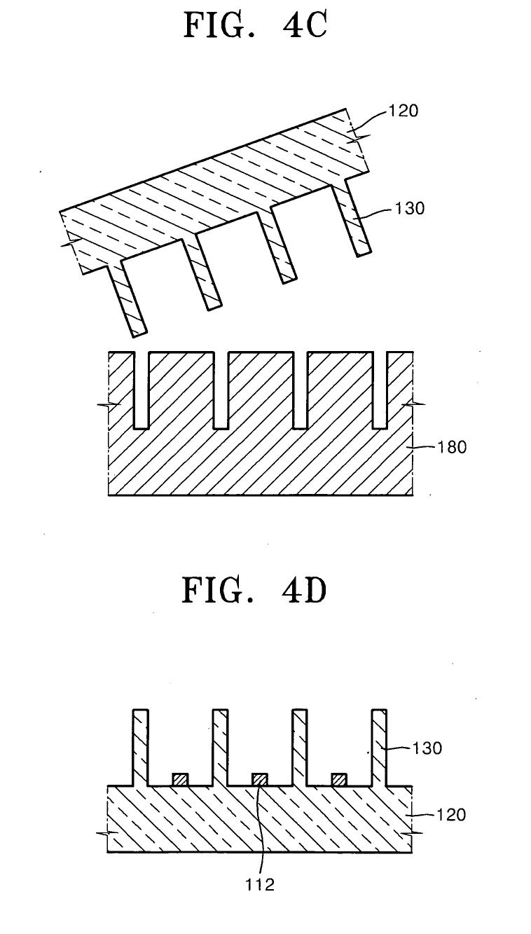

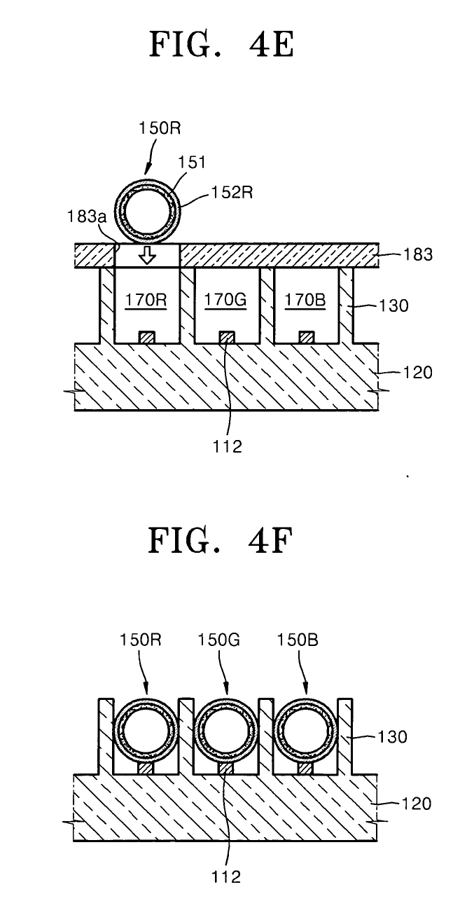

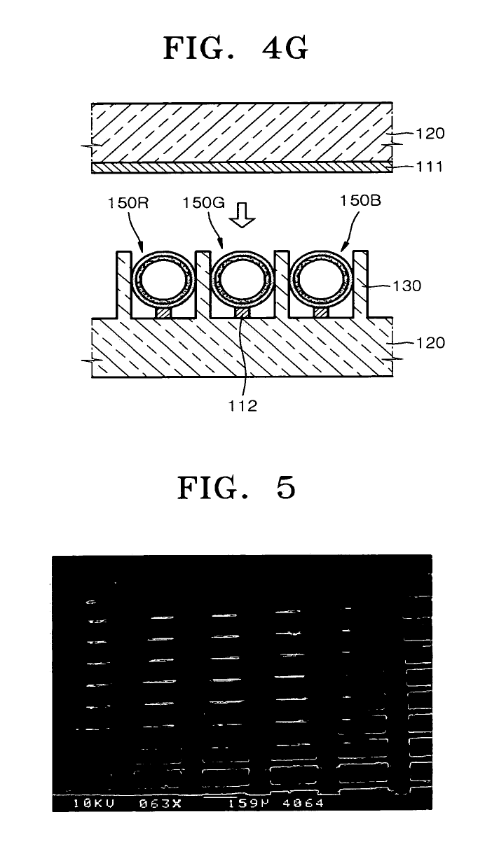

A method of manufacturing the PDP 100 having the above structure will now be described with reference to FIGS. 4A through 4G.

Referring to FIG. 4A, a mold 180 having a shape in which the second substrate 120 and the barrier ribs 130 can be integrated into a single unit is prepared. Next, liquid silicon rubber 181 is injected into the mold 180 in the vacuum state. FIG. 4B illustrates a state where the liquid silicon rubber 181 is injected into the mold 180. The silicon rubber 181 is a two-liquid type silicon rubber and formed by mixing a main agent and a hardener. Referring to FIG. 4B, first, the main agent and the hardener are mixed in the mold 180 at a ratio of approximately 10:1 and vapors in the mixture are sufficiently removed in the vacuum state. The process of removing vapors is performed under a vacuum chamber for about 40 minutes. At this time, the vacuum state should be maintained for a sufficient time so that any extra space is completely filled in a processed groove 180a.

After that, the silicon rubber 181 is solidified. The process of solidifying the silicon rubber 181 is performed in such a manner that the liquid silicon rubber 181 of which vapors are removed is cured at a hot air drying furnace of approximately 40° C. for about one hour. Next, referring to FIG. 4C, the solidified silicon rubber 181 is removed from the mold 180, thereby manufacturing the second substrate 120 and the barrier ribs 130 to be integrated into a single unit. A resultant structure in which the second substrate 120 and the barrier ribs 130 are integrated into a single unit using the process is illustrated in FIG. 5.

After the second substrate 120 and the barrier ribs 130 are manufactured, the second electrodes 112 are patterned on the second substrate 120. FIG. 4D illustrates a state where the second electrodes 112 are formed on the second substrate 120.

Next, a process of inserting the shell structures 150 into the red, green, and blue discharge cells 170 using a mask 183 is performed. A method of manufacturing the shell structures 150 will now be described. A spherical shell 151 having a diameter from about 1 micron to about 1000 microns is manufactured in a chamber in which the discharge gas such as Xe is filled, using micro sphere manufacturing technology disclosed in U.S. Pat. No. 6,669,961 by Kim, et al. issued Dec. 30, 2003, (hereby incorporated in its entirety by reference). After that, phosphor layers 152 are formed on an outer surface of the shell 151 using a spraying or dipping method. As shown in FIG. 4E, after shell structures 150R for red shell structures are formed, the mask 183 is disposed on the barrier ribs 130. The mask 183 has three shapes, so as to insert shell structures 150R, 150G, and 150B for red, green, and blue shell structures into the red, green, and blue discharge cells 170R, 170G, and 170B, respectively. The mask 183 illustrated in FIG. 4E is used for the shell structures 150R for emitting red light disposed in the red discharge cells 170B. Referring to FIG. 4E, an opening 183a is formed only in a portion of the mask 183 which corresponds to the red discharge cells 170R. In addition, each shell structure 150R for emitting red light includes a shell 151, a red light emitting phosphor layer 152R, and a discharge gas. Thus, if all of the shell structures 150R for emitting red light are filled in the red discharge cells 170R, the mask 183 of which opening 183a is formed in a position corresponding to the red or blue discharge cells 170G or 170B is disposed on the barrier ribs 130 so that the shell structures 150G for emitting green light and the shell structures 150B for emitting blue light are filled in the green discharge cells 170G and the blue discharge cells 170B, respectively. FIG. 4F illustrates a state where all of the shell structures 150R, 150G, and 150B are filled in each of the discharge cells 170R, 170G, and 170B.

Next, referring to FIG. 4G, the resultant structure illustrated in FIG. 4F is combined with the inner surface of the first substrate 110 in which the first electrodes 111 are patterned. The first substrate 110 may be formed of silicon rubber. Since the first substrate 110, the second substrate 120, and the barrier ribs 130 have flexibility and buffering characteristics, when the first substrate 110 and the second substrate 120 are pressurized and combined with each other, the shell structures 150R, 150G, and 150B can be fixed in the discharge cells 170R, 170G, and 170B.

The operation of the PDP 100 having the above structure according to the present embodiments will now be described.

An address voltage is applied between the first electrode 111 and the second electrode 112 so that an address discharge occurs. Discharge cells 170 in which a sustain discharge will occur as a result of the address discharge are selected. After that, if a sustain voltage is applied between the first electrode 111 and the second electrode 112 of the selected discharge cells 170, a sustain discharge occurs in the discharge space 180. The energy level of the excited discharge gas during the sustain discharge is reduced and UV rays are emitted. The UV rays excite the phosphor layers 152 coated on the outer side surface of the shell 151 after transmitting through the shell 151. The energy level of the excited phosphor layers 152 is reduced, visible rays are emitted, and the emitted visible rays constitute an image.

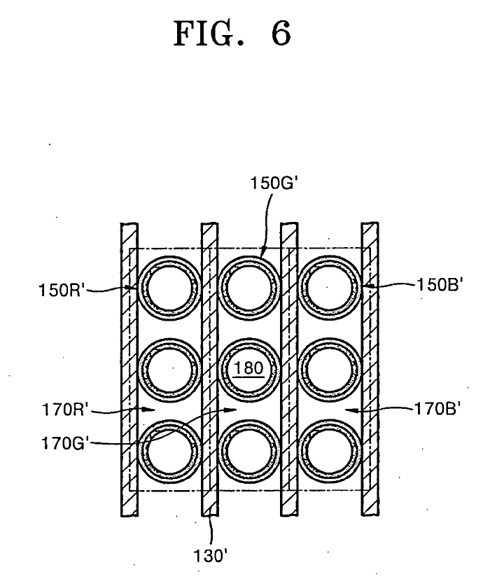

FIG. 6 depicts a partially cross-sectional view of a modified example of the PDP 100 illustrated in FIG. 1. FIG. 6 shows a plurality of shell structures 150R′, 150G′, and 150B′ disposed in each of red, green, and blue discharge cells 170R′, 170G′, and 170B′, which will now be described.

The red, green, and blue discharge cells 170R′, 170G′, and 170B′ are partitioned by stripe-shaped barrier ribs. The three red, green, and blue light emitting shell structures 150R′, 150G′, and 150B′ are disposed in the red, green, and blue discharge cells 170R′, 170G′, and 170B′, respectively. Detailed structure and functions of the red, green, and blue light emitting shell structures 150R′, 150G′, and 150B′ are similar to the above description and thus will be omitted. The shell structures 150R′, 150G′, and 150B′ may have a diameter from about 1 micron to about 1000 microns.

As described above, since a plurality of shell structures is disposed in one discharge cell, a space in the discharge cells can be more frequently used and defects that may occur in the shell structures can be reduced.

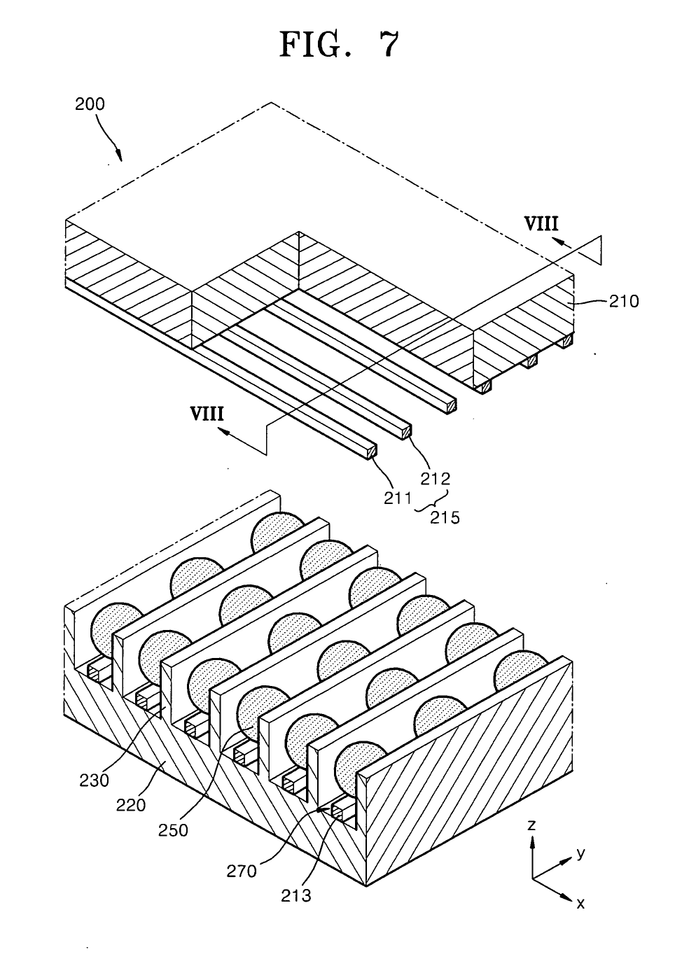

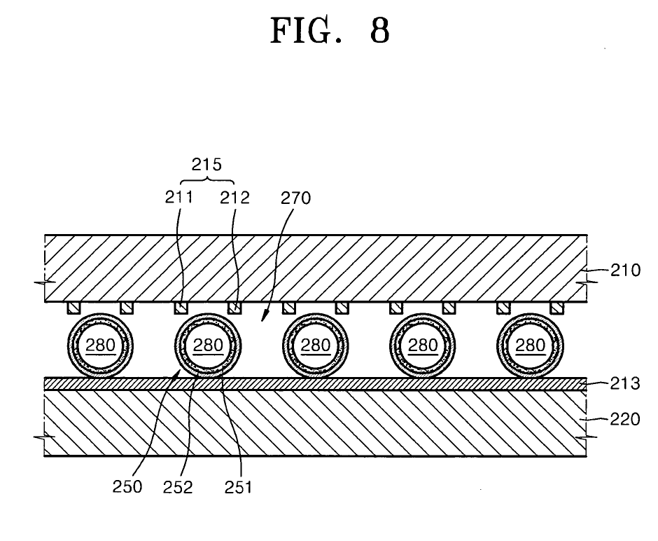

A PDP 200 according to another embodiment will now be described with reference to FIGS. 7 and 8. FIG. 7 is a partially cutaway and exploded perspective view of the PDP 200, and FIG. 8 is a cross-sectional view taken along line VIII-VIII of FIG. 7.

The first substrate 210 and the second substrate 220 are separated from each other by a predetermined gap and oppose each other. Barrier ribs 230 having a striped shape and partitioning a plurality of discharge cells 270 are disposed between the first substrate 210 and the second substrate 220. The barrier ribs 230 and the second substrate 220 are integrated into a single unit. Characteristics of the first substrate 210, the second substrate 220, and the barrier ribs 230 and a method of manufacturing the same are similar to those illustrated in FIG. 6 and thus will be omitted.

A plurality of discharge electrode pairs 215 extends on the first substrate 210 that opposes the second substrate 220, to be parallel to one another. Each discharge electrode pair 215 corresponds to each discharge cell 270 and includes a first discharge electrode 211 and a second discharge electrode 212. Address electrodes 213 are disposed on the second substrate 220 that opposes the first substrate 210 and extend to cross the discharge electrode pairs 215.

Referring to FIG. 8, shell structures 250 are disposed inside the discharge cells 270. Each shell structure 250 includes a spherical shell 251, phosphor layers 252 coated on an outer surface of the shell 251, and a discharge gas filled in a discharge cell 280 inside the shell 251. Referring to FIG. 8, one shell structure 250 corresponds to each discharge cell 270. However, the present embodiments are not limited to this and a plurality of shell structures 250 may be disposed in each discharge cell 270. The structure and function of the shell structure 250 are similar to those illustrated in FIG. 6 and thus will be omitted.

An address voltage is applied between the first discharge electrode 211 and the address electrode 213 so that an address discharge occurs. Discharge cells 270 in which a sustain discharge will occur as a result of the address discharge are selected. After that, if a sustain voltage is applied between the first electrode 211 and the second electrode 212 of the selected discharge cells 270, a sustain discharge occurs in the discharge space 280. The energy level of the excited discharge gas during the sustain discharge is reduced and UV rays are emitted. The UV rays excite the phosphor layers 252 coated on the outer side surface of the shell 251 after transmitting through the shell 251. The energy level of the excited phosphor layers 252 is reduced, visible rays are emitted, and the emitted visible rays constitute an image.

The PDP according to the present embodiments has the following effects. First, since an image is realized by arranging the shell structure having a diameter from about 1 micron to about 1000 microns in the discharge cells, the PDP can be simply manufactured to be highly precise and fine. In particular, a method of coating the phosphor layers is simple and a process of forming an additional dielectric layer is unnecessary.

Second, when the second substrate and the barrier ribs are integrated into a single unit using silicon rubber, the PDP can be simply manufactured and has flexibility. In particular, since the barrier ribs are formed using a molding process, it is advantageous to make the PDP highly precise and fine.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a substrate; and
a shell structure disposed on the substrate comprising a shell wherein a discharge gas is in the shell.

2. The plasma display panel of claim 1, wherein the shell comprises at least one material selected from the group consisting of MgF₂, MgO, SiO₂, and Si₃N₄.

3. The plasma display panel of claim 1, wherein the discharge gas comprises at least one material selected from the group consisting of Hg, N₂, and D₂.

4. The plasma display panel of claim 1, wherein the shell structure further comprises phosphor layers disposed on an outer surface of the shell.

5. The plasma display panel of claim 1, further comprising barrier ribs disposed on the substrate configured to define a space in which the shell structure is arranged.

6. The plasma display panel of claim 1, wherein the barrier ribs and the substrate are integrated into a single unit.

7. The plasma display panel of claim 1, wherein the substrate is a flexible substrate.

8. The plasma display panel of claim 7, wherein the substrate comprises at least one material selected from the group consisting of silicon rubber, polydimethylsiloxane (PDMS), and polyester.

9. The plasma display panel of claim 1, wherein the shell structure is spherical.

10. A plasma display panel comprising:
a first substrate and a second substrate separated from each other by a predetermined gap and opposing each other;
barrier ribs disposed between the first substrate and the second substrate configured to partition a plurality of discharge cells;
discharge electrode pairs configured to cause a discharge in the discharge cells; and
shell structures disposed inside the discharge cells comprising a shell wherein a discharge gas is in the shell.

11. The plasma display panel of claim 10, wherein the shell comprises at least one material selected from the group consisting of MgF₂, MgO, and Si₃N₄.

12. The plasma display panel of claim 10, wherein the discharge gas comprises an inert gas or at least one material selected from the group consisting of Hg, N₂, and D₂.

13. The plasma display panel of claim 10, wherein the shell structure further comprises phosphor layers disposed on an outer surface of the shell.

14. The plasma display panel of claim 10, wherein the first substrate or the second substrate and the barrier ribs are integrated into a single unit.

15. The plasma display panel of claim 10, wherein at least one of the first substrate and the second substrate is a flexible substrate.

16. The plasma display panel of claim 15, wherein at least one of the first substrate and the second substrate comprises at least one material selected from the group consisting of silicon rubber, polydimethylsiloxane (PDMS), and polyester.

17. The plasma display panel of claim 10, wherein the shell structure is spherical.

18. The plasma display panel of claim 10, wherein a plurality of shell structures is disposed in each discharge cell.

19. The plasma display panel of claim 10, wherein each of the discharge electrode pairs comprises a first electrode and a second electrode that extend to cross each other.

20. The plasma display panel of claim 19, wherein the first electrode is disposed on the first substrate that opposes the second substrate and the second electrode is disposed on the second substrate that opposes the first substrate.

21. The plasma display panel of claim 10, wherein each of the discharge electrode pairs comprises a first electrode and a second electrode that extend parallel to each other.

22. The plasma display panel of claim 21, wherein each of the discharge electrode pairs further comprises address electrodes that extend to cross the first electrode and the second electrode.
